(19) United States
(12) Patent Application Publication
(10) Pub. No.: US 2019/0168460 A1
(43) Pub. Date: Jun. 6, 2019

(54) THREE-DIMENSIONAL SHAPING APPARATUS, CONTROL METHOD OF THREE-DIMENSIONAL SHAPING APPARATUS, AND CONTROL PROGRAM OF THREE-DIMENSIONAL SHAPING APPARATUS

(71) Applicant: KANTATSU CO., LTD., Yaita-shi (JP)

(72) Inventors: Eiji OSHIMA, Tochigi (JP); Kazutaka NOBORIMOTO, Tokyo (JP); Akio SAKUMA, Fukushima (JP)

(21) Appl. No.: 16/146,780

(22) Filed: Sep. 28, 2018

(30) Foreign Application Priority Data
Dec. 4, 2017 (JP) 2017-232906

(51) Int. Cl. B29C 64/393; B29C 64/245; B29C 64/135; B33Y 30/00; B33Y 50/02

(52) U.S. Cl. CPC B29C 64/393; B29C 64/245; B33Y 50/02; B33Y 30/00; B29C 64/135

(57) ABSTRACT

A platform is positioned accurately. There is provided a three-dimensional shaping apparatus for shaping a three-dimensional shaped object, including a material storage that stores a material of the three-dimensional shaped object, a platform arranged facing the material storage, a moving unit that moves the platform in a vertical direction, a shaping pad that is provided on a surface, facing the material storage, of the platform, and on which the three-dimensional shaped object is shaped, a first detector that detects downward movement of the material storage, and a movement controller that controls, if the downward movement of the material storage is detected, the movement of the platform by the moving unit.

### CROSS-REFERENCE TO RELATED APPLICATION

This application is based upon and claims the benefit of priority from Japanese patent application No. 2017-232906, filed on Dec. 4, 2017, the disclosure of which is incorporated herein in its entirety by reference.

### BACKGROUND OF THE INVENTION

### Field of the Invention

The present invention relates to a three-dimensional shaping apparatus, a control method of the three-dimensional shaping apparatus, and a control program of the three-dimensional shaping apparatus.

### Description of the Related Art

In the above technical field, patent literature 1 discloses a technique of blocking the lower end of the vertical moving path of a stage by providing, on the inner circumferential surface of a frame portion, a contact portion protruding inward.

[Patent Literature 1] Japanese Patent Laid-Open No. 2013-75389

### SUMMARY OF THE INVENTION

In the technique described in the above literature, however, it is impossible to position a platform accurately.

The present invention enables to provide a technique of solving the above-described problem.

One example aspect of the present invention provides a three-dimensional shaping apparatus for shaping a three-dimensional shaped object, comprising:

a material storage that stores a material of the three-dimensional shaped object;

a platform arranged facing the material storage;

a moving unit that moves the platform in a vertical direction;

a shaping pad that is provided on a surface, facing the material storage, of the platform, so that the three-dimensional shaped object is shaped;

a first detector that detects downward movement of the material storage; and

a movement controller that controls, if the downward movement of the material storage is detected, the movement of the platform by the moving unit.

Another example aspect of the present invention provides a control method of a three-dimensional shaping apparatus for shaping a three-dimensional shaped object, including

a material storage that stores a material of the three-dimensional shaped object,

a platform arranged facing the material storage,

a moving unit that moves the platform in a vertical direction,

a shaping pad that is provided on a surface, facing the material storage, of the platform, so that the three-dimensional shaped object is shaped,

a first detector that detects downward movement of the material storage, and

a movement controller that controls, if the downward movement of the material storage is detected, the movement of the platform by the moving unit,

the method comprising:

causing the moving unit to move the platform in the vertical direction;

detecting the downward movement of the material storage; and

controlling, if the downward movement of the material storage is detected, the movement of the platform by the moving unit.

Still other example aspect of the present invention provides a control program of a three-dimensional shaping apparatus for shaping a three-dimensional shaped object, including

a material storage that stores a material of the three-dimensional shaped object,

a platform arranged facing the material storage,

a moving unit that moves the platform in a vertical direction,

a shaping pad that is provided on a surface, facing the material storage, of the platform, so that the three-dimensional shaped object is shaped,

a first detector that detects downward movement of the material storage, and

a movement controller that controls, if the downward movement of the material storage is detected, the movement of the platform by the moving unit,

the program for causing a computer to execute a method, comprising:

causing the moving unit to move the platform in the vertical direction;

detecting the downward movement of the material storage; and

controlling, if the downward movement of the material storage is detected, the movement of the platform by the moving unit.

According to the present invention, it is possible to position a platform accurately.

### BRIEF DESCRIPTION OF THE DRAWINGS

FIG. 1 is a view showing the arrangement of a three-dimensional shaping apparatus according to the first example embodiment of the present invention;

FIG. 2A is a perspective view showing an outline of the arrangement of a three-dimensional shaping apparatus according to the second example embodiment of the present invention;

FIG. 2B is a plan view showing the arrangement of the three-dimensional shaping apparatus according to the second example embodiment of the present invention;

FIG. 2C is a schematic side view showing the arrangement of the three-dimensional shaping apparatus according to the second example embodiment of the present invention;

FIG. 2D is a schematic front view for explaining an outline of the operation of the three-dimensional shaping apparatus according to the second example embodiment of the present invention;

FIG. 3A is a view for explaining alignment of a platform by the three-dimensional shaping apparatus according to the second example embodiment of the present invention;

FIG. 3B is a view for explaining the alignment of the platform by the three-dimensional shaping apparatus according to the second example embodiment of the present invention;

FIG. 3C is a view for explaining the alignment of the platform by the three-dimensional shaping apparatus according to the second example embodiment of the present invention;

FIG. 3D is a view for explaining the alignment of the platform by the three-dimensional shaping apparatus according to the second example embodiment of the present invention;

FIG. 3E is a view for explaining the alignment of the platform by the three-dimensional shaping apparatus according to the second example embodiment of the present invention;

FIG. 3F is a view for explaining the alignment of the platform by the three-dimensional shaping apparatus according to the second example embodiment of the present invention;

FIG. 3G is a view for explaining the alignment of the platform by the three-dimensional shaping apparatus according to the second example embodiment of the present invention;

FIG. 3H is a view for explaining the alignment of the platform by the three-dimensional shaping apparatus according to the second example embodiment of the present invention;

FIG. 3I is a view for explaining the alignment of the platform by the three-dimensional shaping apparatus according to the second example embodiment of the present invention;

FIG. 3J is a view for explaining the alignment of the platform by the three-dimensional shaping apparatus according to the second example embodiment of the present invention;

FIG. 4 is a view showing an outline of the arrangement of a three-dimensional shaping apparatus according to third example embodiment of the present invention; and

FIG. 5 is a flowchart for explaining the operation procedure of the three-dimensional shaping apparatus according to third example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

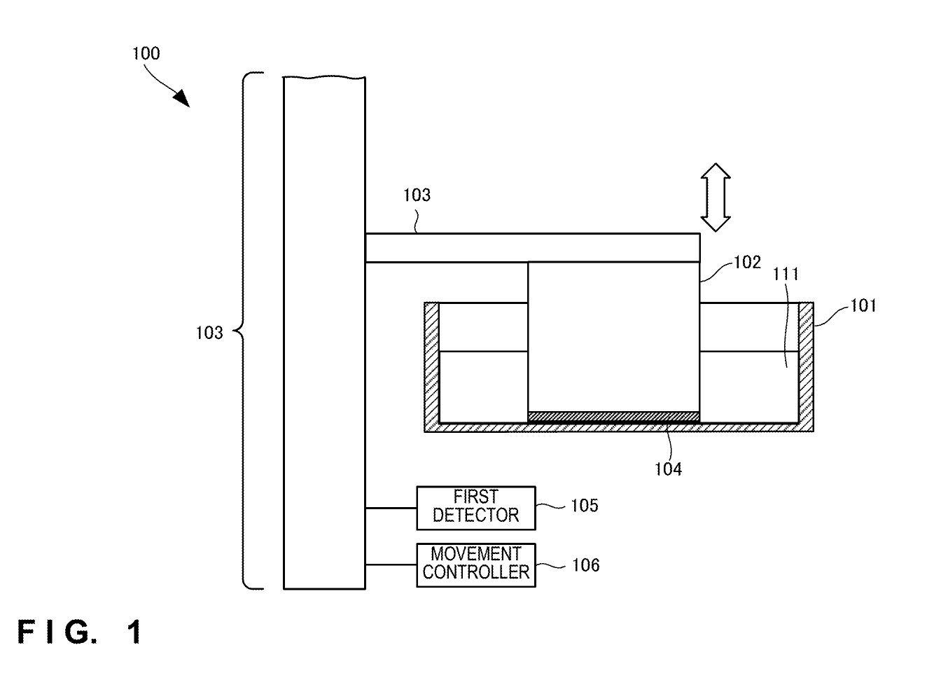

A three-dimensional shaping apparatus 100 according to the first example embodiment of the present invention will be described with reference to FIG. 1. The three-dimensional shaping apparatus 100 is an apparatus that shapes a three-dimensional shaped object by irradiating a material of the three-dimensional shaped object with a light beam.

As shown in FIG. 1, the three-dimensional shaping apparatus 100 includes a material storage 101, a platform 102, a moving unit 103, a shaping pad 104, a first detector 105, and a movement controller 106.

The material storage 101 stores a material 111 of a three-dimensional shaped object. The platform 102 is arranged facing the material storage 101. The moving unit 103 moves the platform 102 in the vertical direction. The shaping pad 104 is provided on a surface, facing the material storage 101, of the platform 102, so that the three-dimensional shaped object is shaped. The first detector 105 detects downward movement of the material storage 101. If downward movement of the material storage 101 is detected, the movement controller 106 controls the movement of the platform 102 by the moving unit 103.

According to this example embodiment, it is possible to position the platform accurately.

### Second Example Embodiment

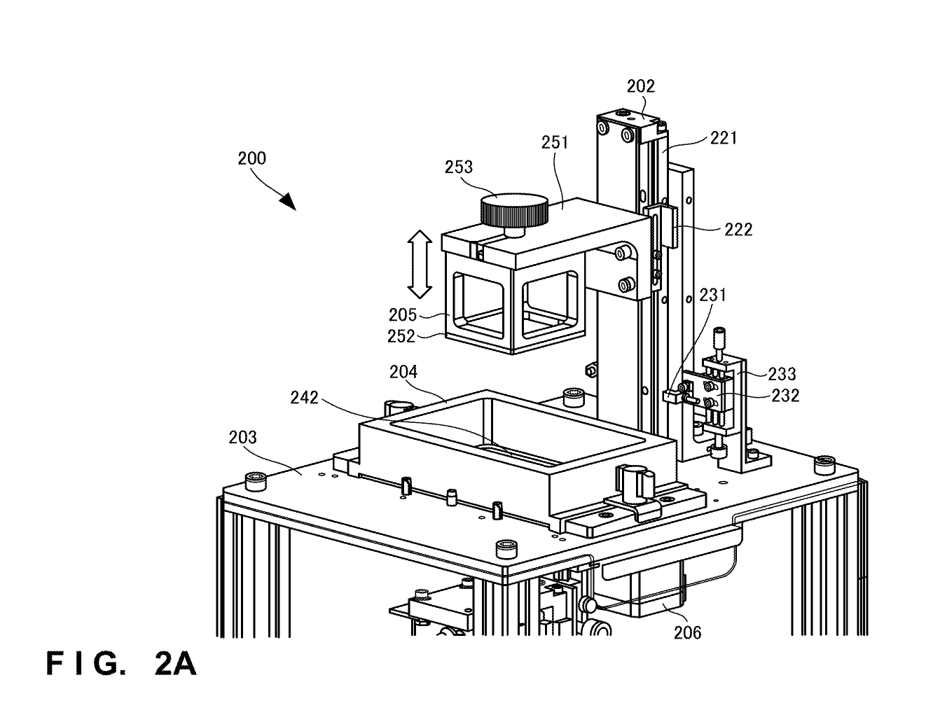

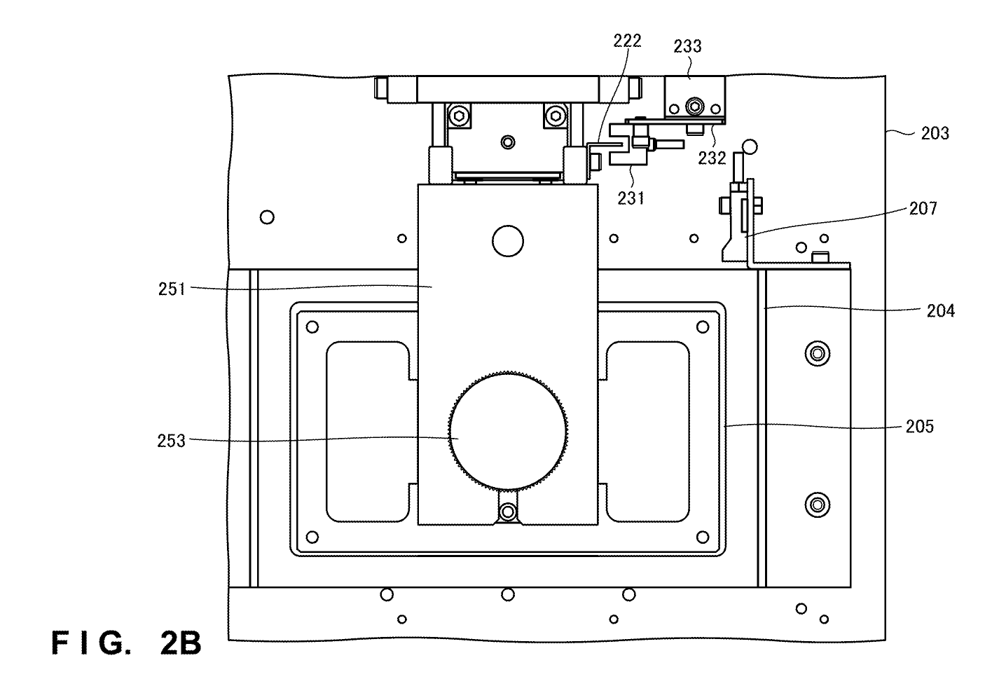

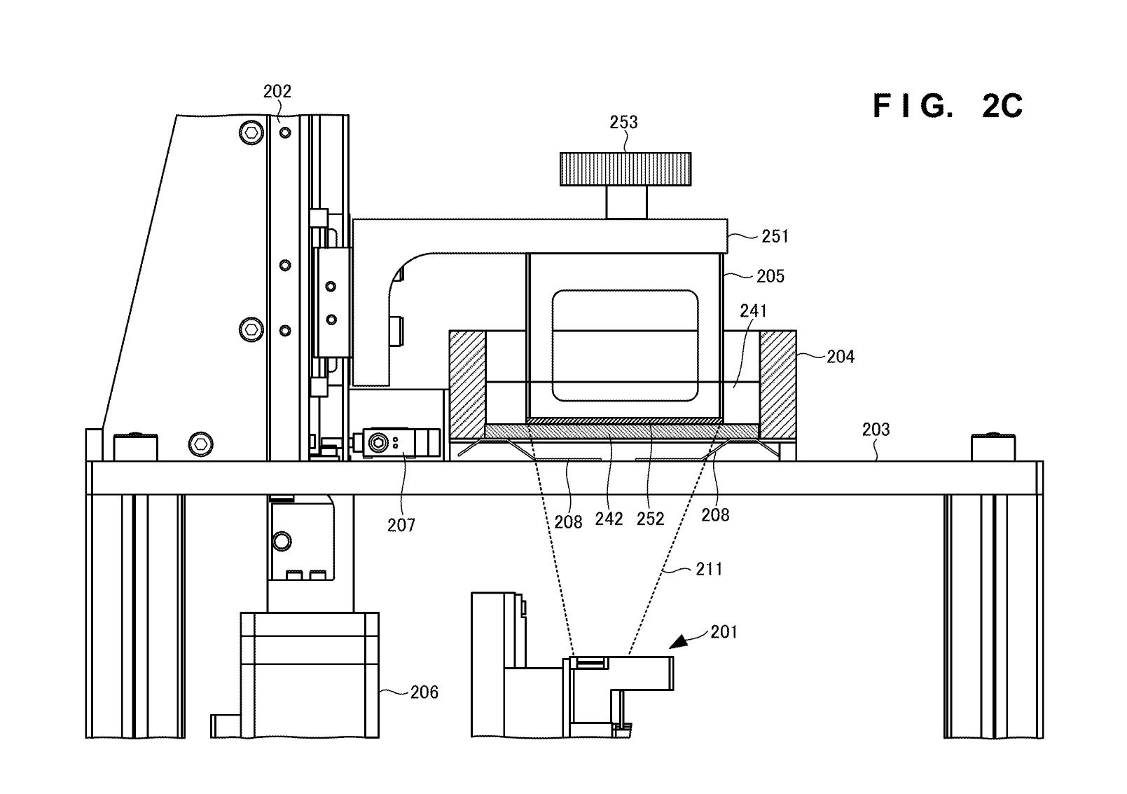

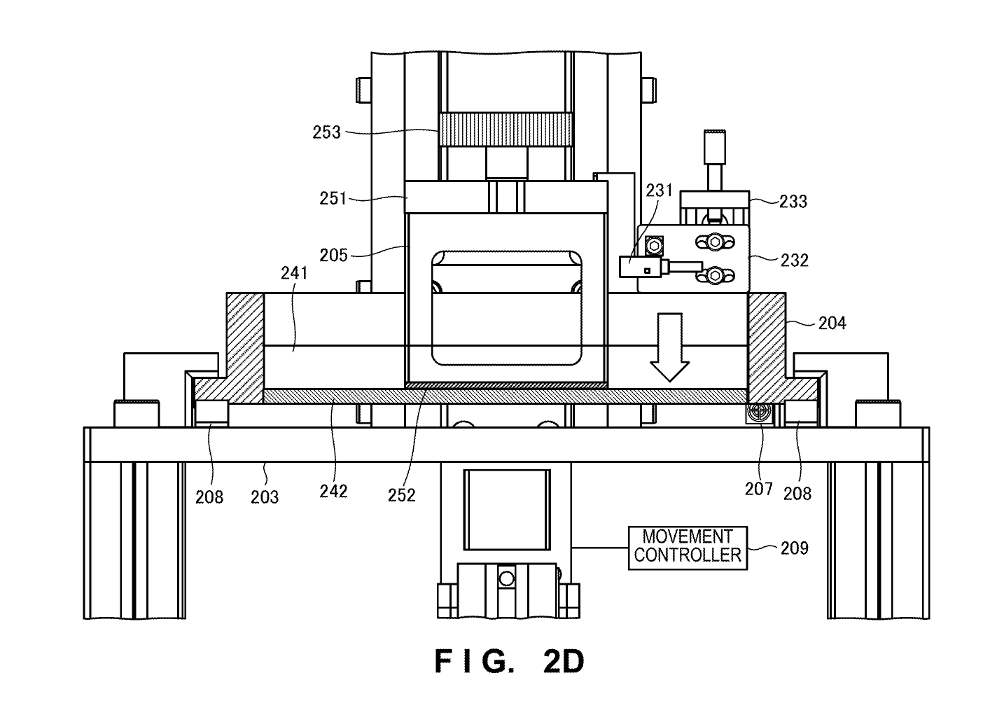

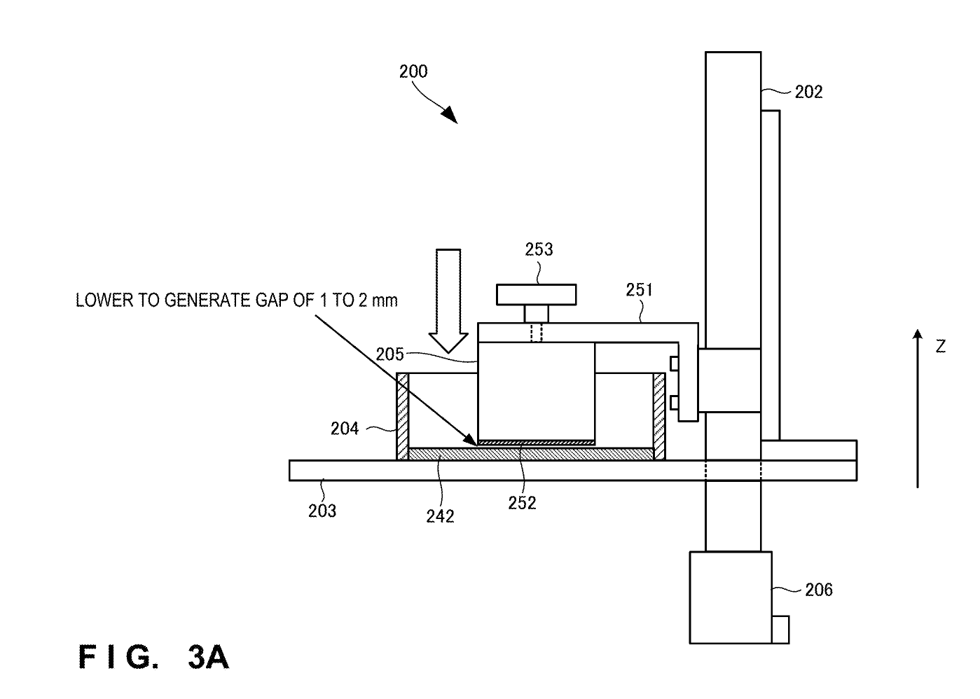

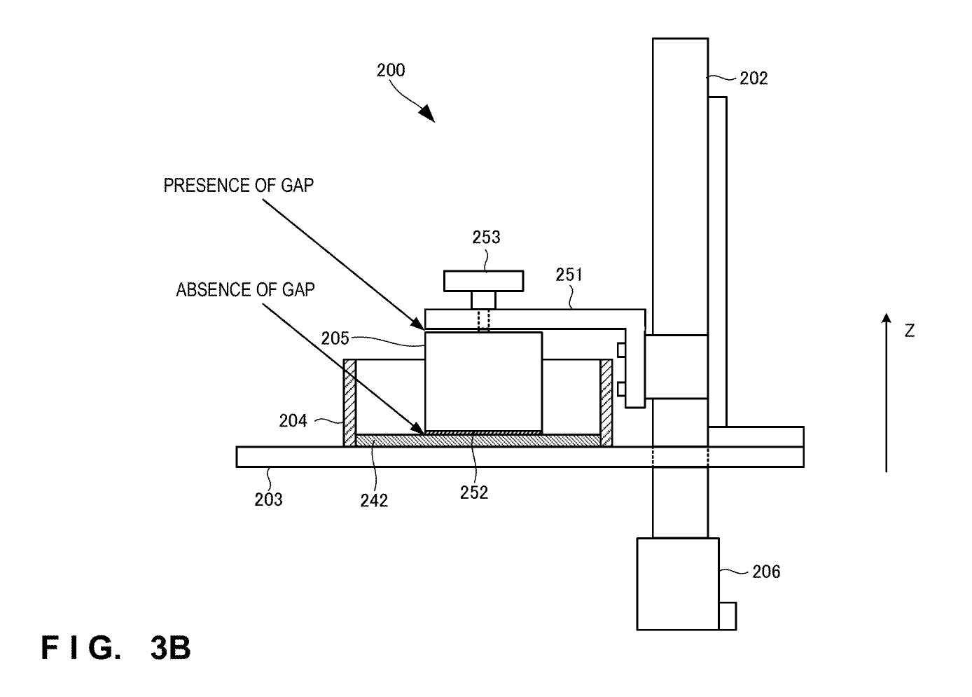

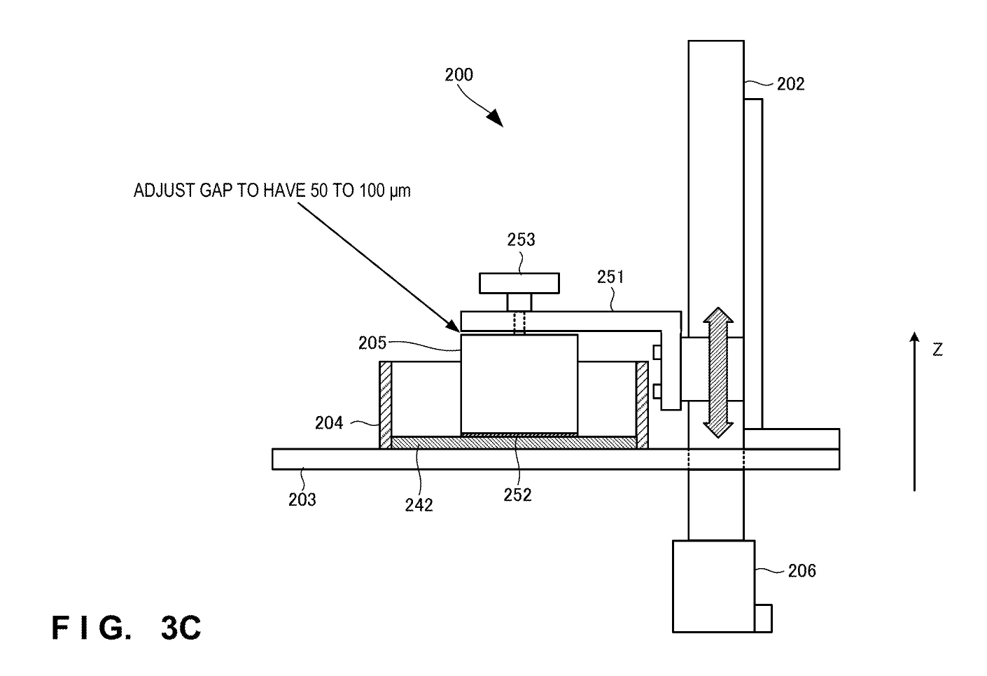

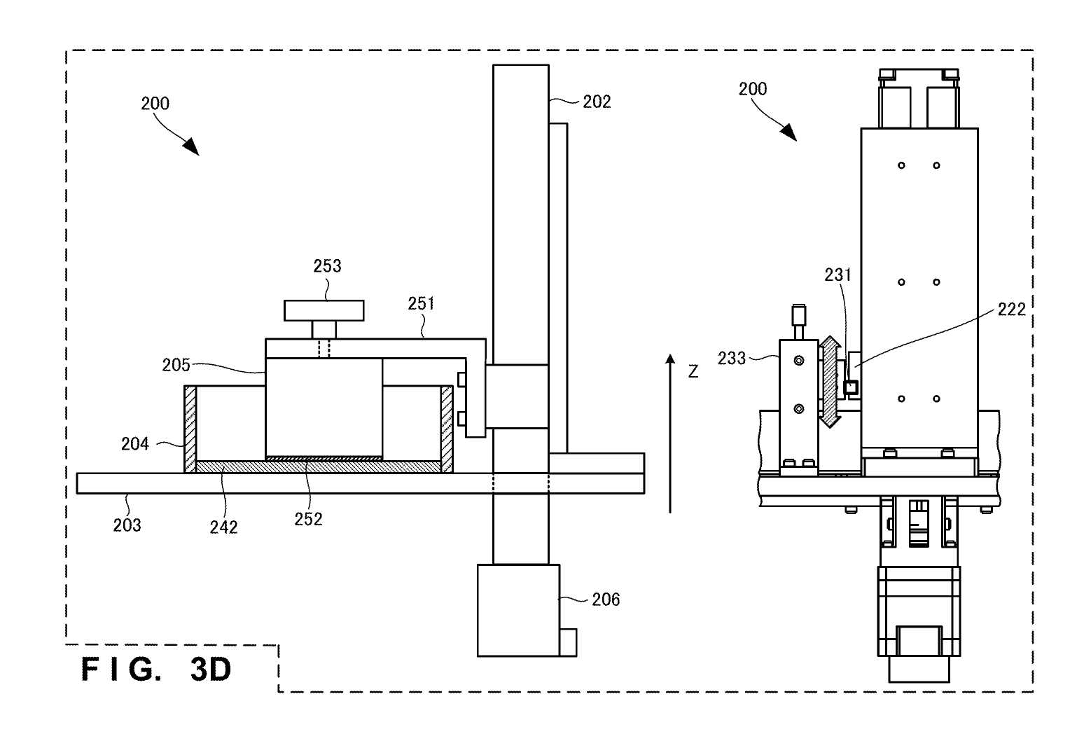

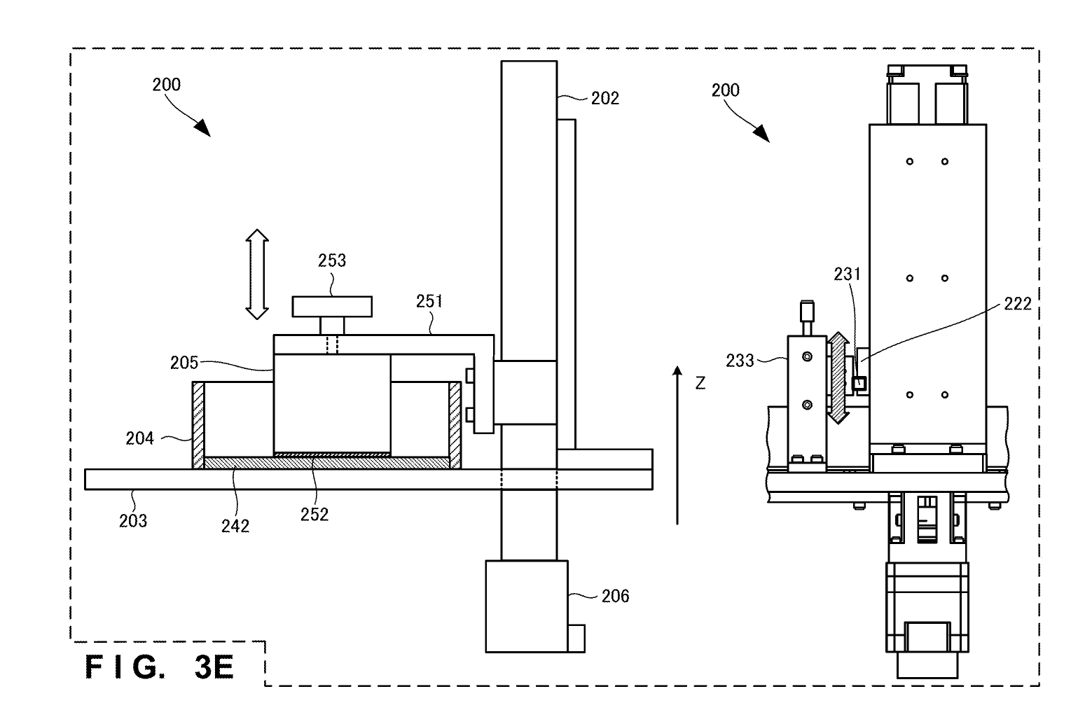

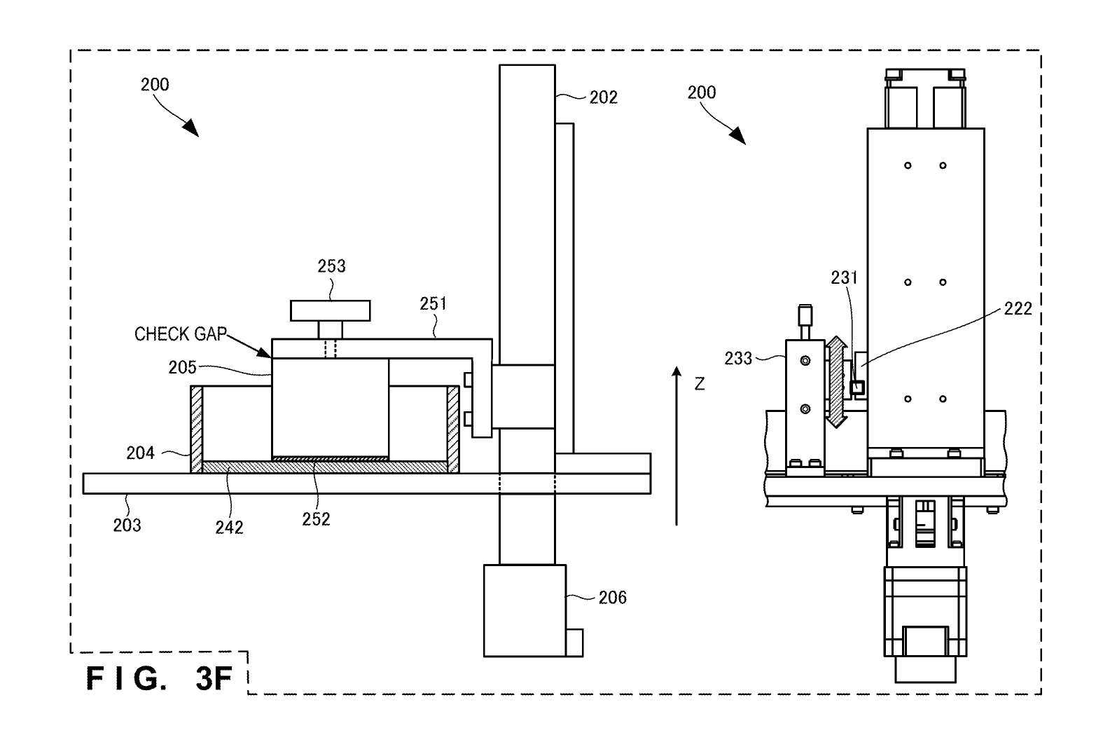

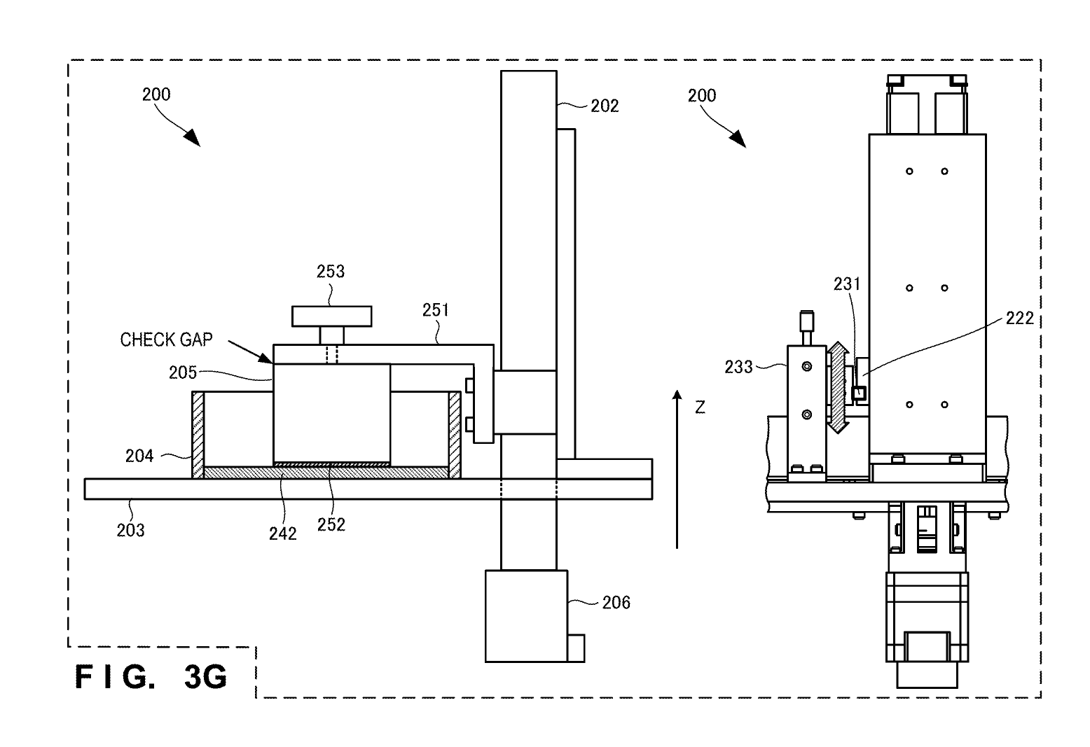

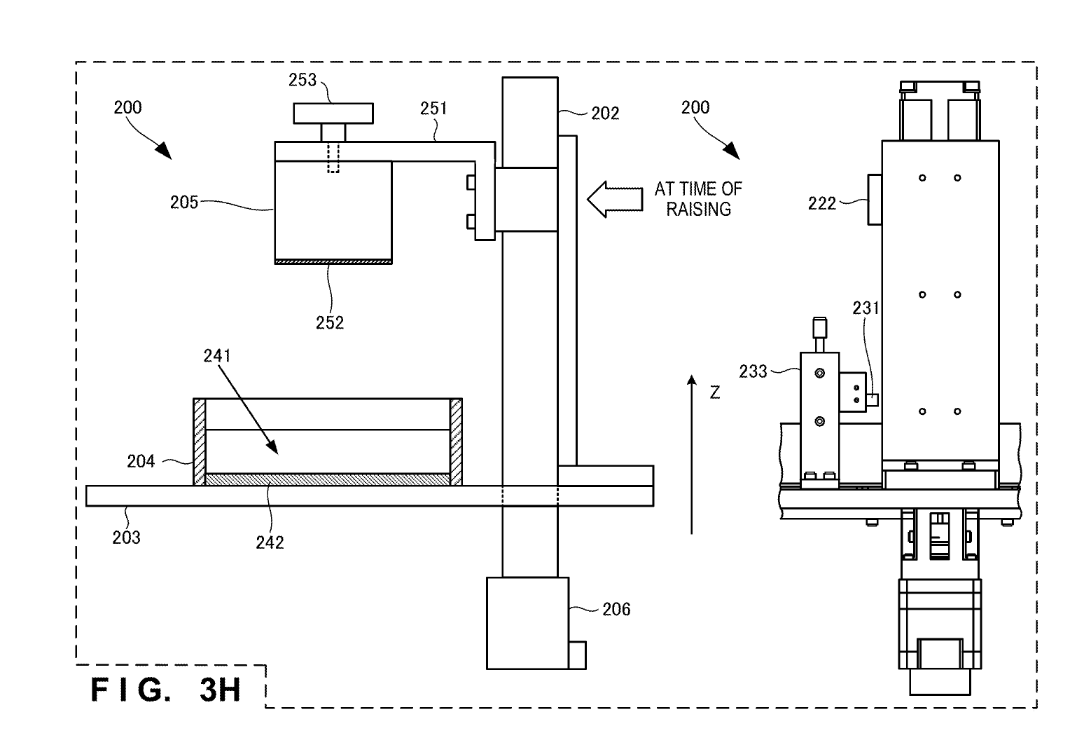

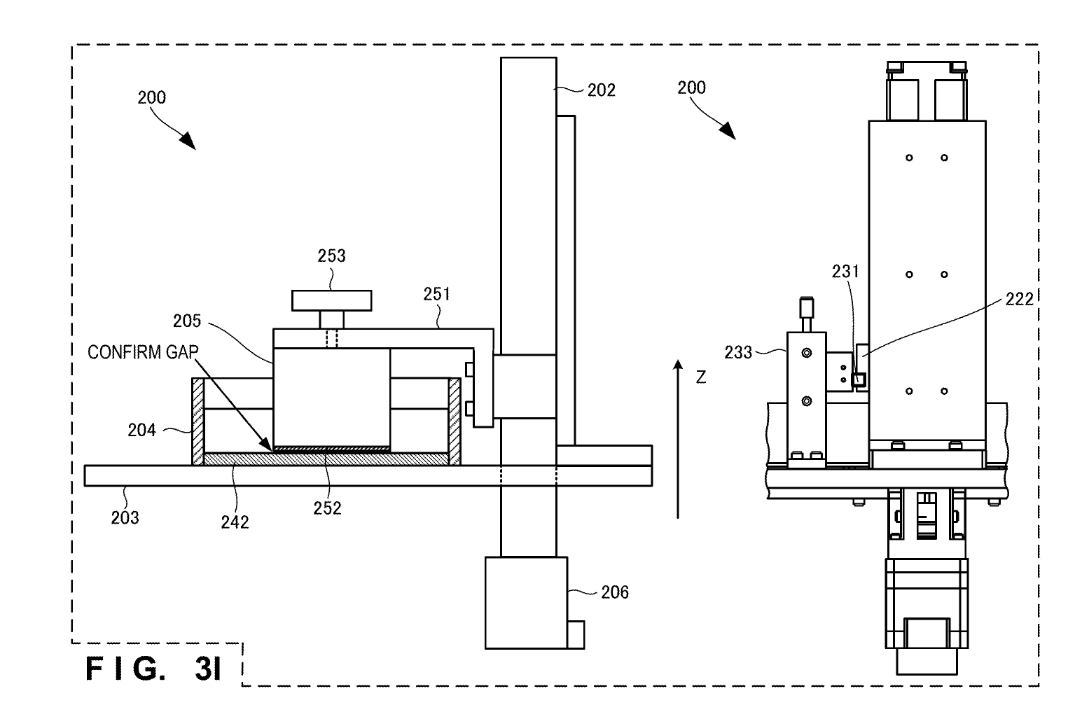

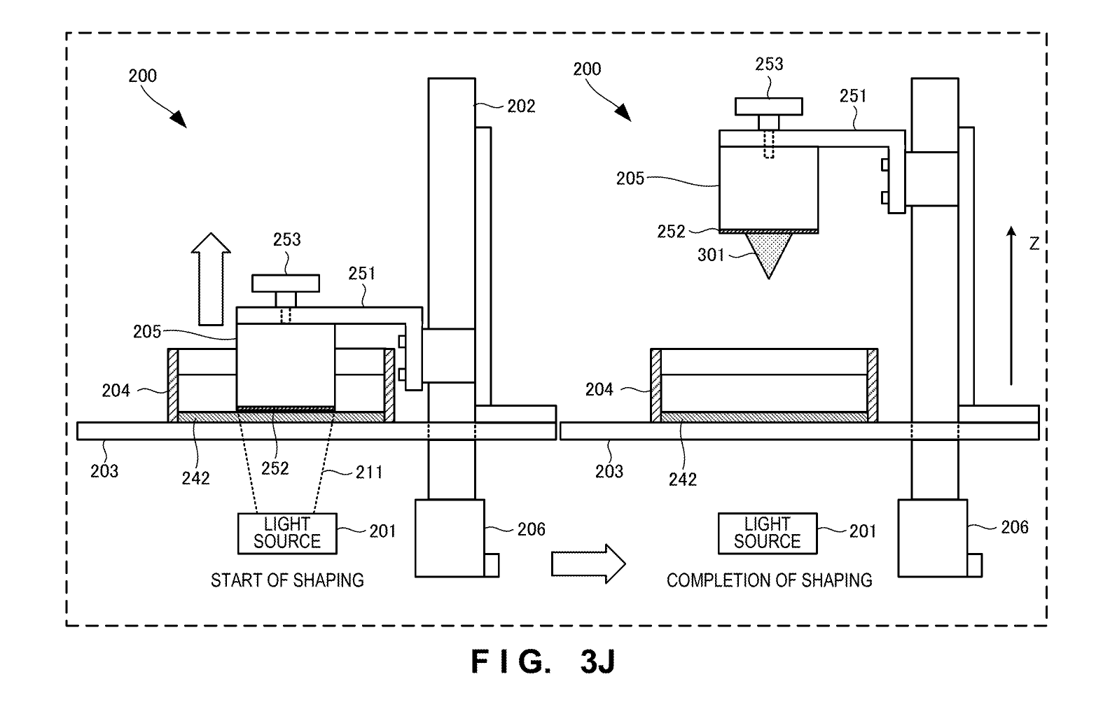

A three-dimensional shaping apparatus according to the second example embodiment of the present invention will be described with reference to FIGS. 2A to 3J.

FIG. 2A is a perspective view showing an outline of the arrangement of the three-dimensional shaping apparatus according to this example embodiment. FIG. 2B is a plan view showing the arrangement of the three-dimensional shaping apparatus according to this example embodiment. FIG. 2C is a schematic side view showing the arrangement of the three-dimensional shaping apparatus according to this example embodiment.

A three-dimensional shaping apparatus 200 includes a light source 201, a column 202, a table 203, a material storage 204, a platform 205, a stepping motor 206, a proximity sensor 207, and a supporter 208.

The light source 201 emits a light beam 211 with which a material 241 of a three-dimensional shaped object is irradiated. The material 241 is, for example, a photo-curing resin. The light beam 211 with which the material 241 is irradiated may be any light beam 211 as long as it has a wavelength that can cure the material 241 of the three-dimensional shaped object. The light beam 211 has, for example, a wavelength of 405 nm but may have a wavelength of 200 nm to 400 nm. The present invention is not limited to this.

The table 203 is attached to the column 202. A photosensor 231 is attached to the table 203 via a sensor supporter (sensor bracket) 232. The position of the photosensor 231 is adjusted using a sensor adjustment stage 233.

The material storage (vat) 204 is placed on the table 203. The material 241 of the three-dimensional shaped object is charged and stored in the material storage 204. A bottom surface 242 of the material storage 204 is formed by including a member capable of transmitting the light beam 211. The member capable of transmitting the light beam 211 is represented by, for example, a glass member but the present invention is not limited to this. The entire material storage 204 may be formed by a member capable of transmitting the light beam 211. Note that the material storage 204 may be fixed to a predetermined position on the table 203 by a screw or the like, or may simply be placed on the table 203. A method of placing the material storage 204 on the table 203 is not limited to them.

The platform 205 is attached to a platform support member 251 by a platform mounting screw 253. In addition, the platform 205 is attached to the column 202 via the platform support member 251. The platform 205 can be detached from the platform support member 251 by loosening the platform mounting screw 253. The platform 205 can be fixed to the platform support member 251 by tightening the platform mounting screw 253.

The platform 205 is arranged facing the material storage 204. A shaping pad 252 on which a three-dimensional shaped object is shaped is provided on a surface, facing the material storage 204, of the platform 205. A three-dimensional shaped object is shaped on the shaping pad 252.

A linear actuator 221 and the stepping motor 206 are provided in the column 202. The platform 205 can be moved in the vertical direction by a moving unit including the platform support member 251, the linear actuator 221, and the stepping motor 206. The position of the platform 205 can be detected using a contact bracket 222 and the photosensor 231.

The proximity sensor 207 is arranged on the table 203. The proximity sensor 207 is arranged between the material storage 204 and the column 202. Then, the proximity sensor 207 detects movement of the material storage 204 in a direction (downward direction) in which the material storage 204 approaches the table 203. Note that the arrangement position of the proximity sensor 207 is not limited to the above-described one, and may be any position at which the movement of the material storage 204 can be detected.

Instead of detecting the downward movement of the material storage 204 using the proximity sensor 207, the downward movement of the material storage 204 may be detected using a mechanical switch or the like.

The supporter 208 supports the material storage 204 from the side of the bottom surface 242 of the material storage 204. The supporter 208 is arranged between the table 203 and the material storage 204. The material storage 204 floats from the table 203 by the supporter 208. In this example, the supporter 208 is a member such as a spring that is deflected when applied with a load. The supporter 208 is a member that has a strength enough to reliably support the material storage 204 not to move its position in a normal state but is deflected when a load is applied to the material storage 204. Note that one or a plurality of supporters 208 may be provided on the side of the table 203 of the bottom surface 242 of the material storage 204. A position at which the supporter 208 is arranged is not limited, and may be, for example, a position at which the light beam 211 from the light source 201 is not blocked. Furthermore, the supporter 208 is made of, for example, a material capable of transmitting the light beam 211.

If the downward movement of the material storage 204 is detected, a movement controller 209 controls the movement of the platform 205 by the moving unit in correspondence with the position of the platform 205. If the downward movement of the material storage 204 is detected, for example, the movement controller 209 stops the movement of the platform 205. Since this stops the movement of the platform 205, the material storage 204 does not lower downward, and thus no excessive load is applied to the bottom surface 242, thereby making it possible to prevent damage to the bottom surface 242.

FIG. 2D is a schematic front view for explaining an outline of the operation of the three-dimensional shaping apparatus according to this example embodiment. As shown in FIG. 2D, the material storage 204 is supported by the supporter 208 to float from the table 203. If the material storage 204 is pressed by the platform 205 or the like to move (lower) downward (in the direction of an arrow in FIG. 2D), the proximity sensor 207 detects the downward movement of the material storage 204. Then, if the downward movement of the material storage 204 is detected, the movement controller 209 stops the movement of the platform 205.

When shaping a three-dimensional shaped object, the platform 205 is moved downward and positioned so that the shaping pad 252 contacts the bottom surface 242 of the material storage 204. In this case, if the downward movement of the material storage 204 is detected using the proximity sensor 207, the movement controller 209 stops the downward movement of the platform 205. Therefore, it is possible to prevent damage to the bottom surface 242 caused by an excessive load applied from the platform 205 (shaping pad 252) to the bottom surface 242 of the material storage 204.

Note that although not shown, the three-dimensional shaping apparatus 200 may be provided with a notifier that sends an alert notification based on the detection results of the photosensor 231 and the proximity sensor 207 or the detection result of one of the photosensor 231 and the proximity sensor 207. The alert notification sent by the notifier is implemented by a sound, light, a vibration, a text message, or the like. However, the present invention is not limited to them.

A procedure of positioning the platform 205 will be described next with reference to FIGS. 3A to 3J. As shown in FIG. 3A, for example, the position of the platform 205 in the vertical direction (plumb direction) is adjusted (Z-axis position adjustment) in a manual mode of software for controlling the three-dimensional shaping apparatus 200, and the platform 205 is lowered to a position near the bottom surface 242, made of glass, of the material storage 204. That is, if the platform support member 251 is moved in the vertical direction using the movement controller 209, the platform 205 also moves in the vertical direction in accordance with the movement of the platform support member 251.

The platform 205 is gradually, finely moved by visual observation by adjusting the moving distance of the platform 205 in the vertical direction (Z-axis direction) by, for example, 10 mm, 1 mm, or 0.1 mm. Then, the platform 205 is moved and lowered to a position at which a gap of 1 to 2 mm is generated between the shaping pad 252 provided on the platform 205 and the bottom surface 242 of the material storage 204.

As shown in FIG. 3B, the shaping pad 252 (shaping pad surface) and the bottom surface 242 are mated with each other by loosening the platform mounting screw 253 of the platform 205. The platform mounting screw 253 is loosened to generate no gap between the shaping pad 252 and the bottom surface 242 and generate a gap between the platform 205 and the platform support member 251. That is, the platform 205 is separated from the platform support member 251 by loosening the platform mounting screw 253, and drops downward, thereby making it possible to mate the shaping pad 252 and the bottom surface 242 with each other.

As shown in FIG. 3C, adjustment is performed so as to generate a gap of 50 to 100 μm between the platform 205 and the platform support member 251. That is, as shown in FIG. 3B, in this state, the platform mounting screw 253 is loosened. Thus, even if the platform support member 251 is moved in the vertical direction using the movement controller 209, the platform 205 does not move in the vertical direction. Therefore, the platform support member 251 is moved in the vertical direction to generate a gap of 50 to 100 μm between the platform 205 and the platform support member 251.

Note that in this case, if the photosensor 231 operates (an LED (Light Emitting Diode) is turned off) to prevent the position of the platform support member 251 from being lowered, the sensor adjustment stage 233 is used to lower the position of the photosensor 231. In this way, by lowering the position of the photosensor 231, the position of the platform 205 can be further lowered (adjusted to a position at which the LED is turned on).

As shown in the left view of FIG. 3D, after the gap between the platform 205 and the platform support member 251 can be adjusted to have 50 to 100 μm, the platform mounting screw 253 is tightened to fix the platform 205 to the platform support member 251. Then, as shown in the right view of FIG. 3D, after the position of the platform 205 can be fixed, the photosensor 231 is finely adjusted to a position at which the LED is turned off (a position at which the LED is just turned off).

In this state, Z-axis origin return of the software for controlling the three-dimensional shaping apparatus 200 is turned on. That is, this state is set as the reference position of the position of the platform 205. After the platform 205 is raised, the platform is lowered slowly, and stopped at a position where the LED of the photosensor 231 is turned off (see the right view of FIG. 3E).

As shown in the left view of FIG. 3F, the platform mounting screw 253 is loosened, and the gap between the platform 205 and the platform support member 251 is checked. As shown in the right view of FIG. 3F, if the checked gap is large, the position of the photosensor 231 is lowered. If the checked gap is small, the position of the photosensor 231 is raised.

As shown in FIG. 3G, while checking the gap between the platform 205 and the platform support member 251, the procedure shown in FIGS. 3E and 3F is repeated to loosen the platform mounting screw 253 and fix the position of the platform 205, thereby determining the origin setting position. That is, if a slice has 50 μm, the gap between the platform 205 and the platform support member 251 is set to about 50 μm. If the slice has 5 μm, setting is made to generate no gap (a state in which the platform 205 and the platform support member 251 are in tight contact with each other but are not pressed against each other). The slice represents the setting value for the Z-axis at the time of three-dimensional shaping. As the setting value is smaller, shaping is performed more precisely.

As shown in FIG. 3H, the position of the platform 205 is largely raised upward (for example, by 50 mm), and a resin or the like is charged as the material 241 to the material storage 204.

As shown in FIG. 3I, after the material 241 is charged, the position of the platform 205 is lowered to the origin setting position to immerse the shaping pad 252 in the material 241, and the gap between the shaping pad 252 and the bottom surface 242 of the material storage 204 is confirmed. If it is necessary to adjust the gap between the shaping pad 252 and the bottom surface 242 of the material storage 204, the procedure shown in FIGS. 3F, 3G, and 3I is repeated.

As shown in the left view of FIG. 3J, while the platform 205 is raised, the material 241 is irradiated with the light beam 211 from the light source 201 located under the material storage 204, thereby starting shaping of a three-dimensional shaped object 301. As shown in the right view of FIG. 3J, if the shaping of the three-dimensional shaped object 301 ends and another platform 205 is attached to the platform support member 251, the procedure shown in FIG. 3I is performed to confirm and adjust the position of the platform 205.

According to this example embodiment, since the platform 205 can be aligned accurately, it is possible to align the platform 205 and the bottom surface 242 of the material storage 204 correctly. In addition, since the platform 205 and the bottom surface 242 can be aligned correctly, it is possible to shape a high-precision three-dimensional shaped object, for example, a three-dimensional shaped object with an accuracy of the order of several microns.

Furthermore, according to this example embodiment, since the downward movement of the material storage 204 is detected by the proximity sensor 207 and the supporter 208 at the time of alignment of the platform 205, the bottom surface 242 (glass thereof) of the material storage 204 is never damaged.

### Third Example Embodiment

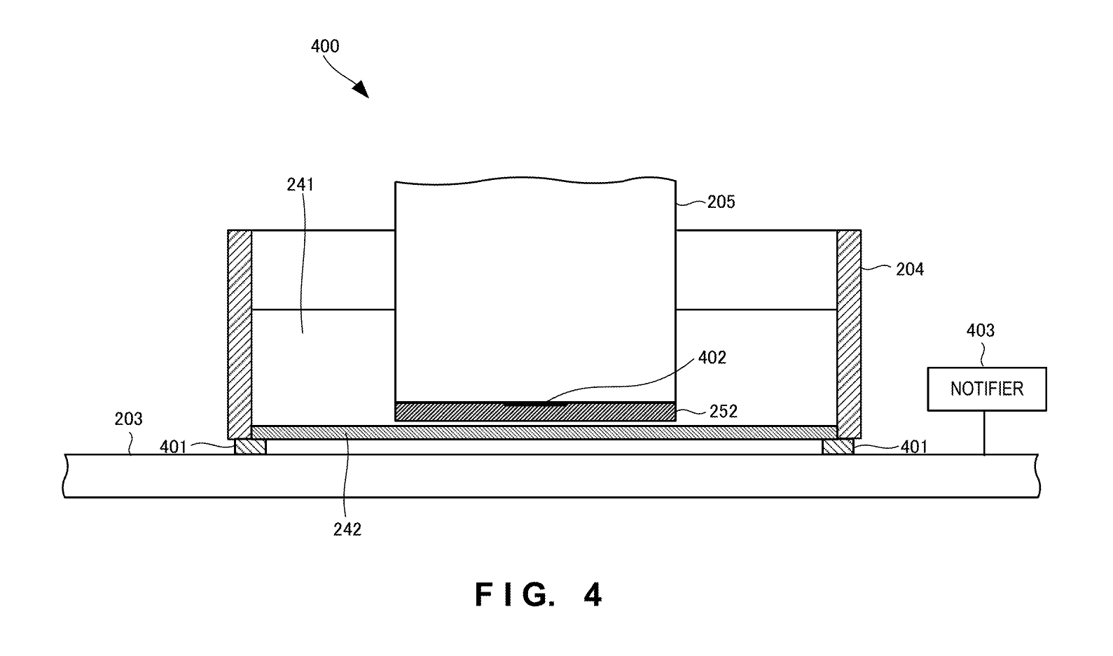

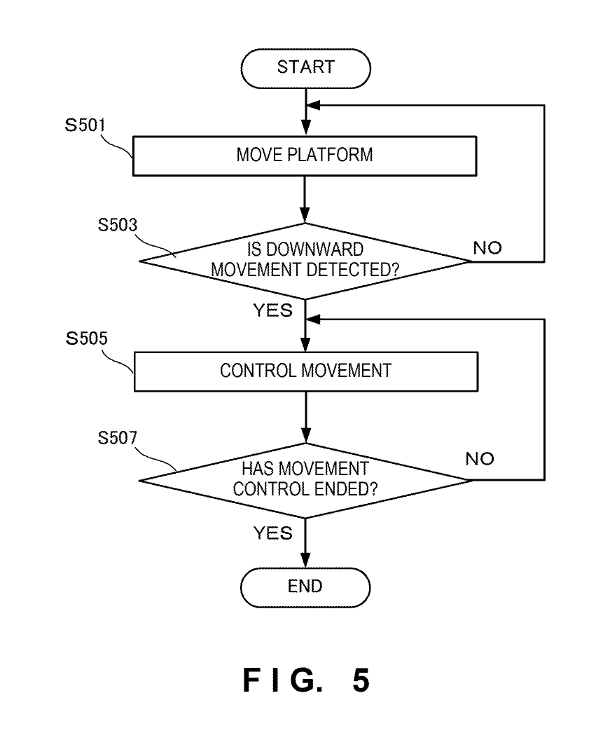

A three-dimensional shaping apparatus according to the third example embodiment of the present invention will be described with reference to FIGS. 4 and 5. FIG. 4 is a view showing an outline of the arrangement of the three-dimensional shaping apparatus according to this example embodiment. Note that elements unnecessary for the description are not illustrated in FIG. 4, as needed. The three-dimensional shaping apparatus according to this example embodiment is different from the above-described second example embodiment in that elastic members, a load detector, and a notifier are provided. The remaining components and operations are the same as those in the second example embodiment. Hence, the same reference numerals denote the same components and operations, and a detailed description thereof will be omitted.

A three-dimensional shaping apparatus 400 further includes elastic members 401, a load detector 402, and a notifier 403.

The elastic members 401 are provided on the lower surface of a material storage 204. That is, the elastic members 401 are provided between a table 203 and the material storage 204. The elastic members 401 serve as cushions that absorb a pressure applied from a platform 205 when the material storage 204 is pressed by the platform 205. That is, if the table 203 and a bottom surface 242 of the material storage 204 are in direct contact with each other, the material storage 204 cannot avert the pressure applied from the platform 205. Thus, the bottom surface 242 of the material storage 204 may be damaged. However, it is possible to prevent damage to the bottom surface 242 by providing the elastic members 401 between the table 203 and the bottom surface 242 of the material storage 204, since the elastic members 401 absorb the pressure applied from the platform 205 to the material storage 204.

The load detector 402 is provided between the platform 205 and a shaping pad 252. The load detector 402 detects a load applied to the material storage 204. Since the material storage 204 is provided with the elastic members 401, the elastic members 401 can absorb a load to some extent. However, if an excessive load is applied, the bottom surface 242 is unwantedly damaged. To solve this problem, by using the load detector 402 to detect a load applied to the material storage 204, it is possible to prevent damage to the bottom surface 242 of the material storage 204 and position the platform 205 more correctly.

The notifier 403 sends an alert notification based on the detection result of the load detector 402. The alert notification sent by the notifier 403 is implemented by a sound, light, a vibration, a text message, or the like. However, the present invention is not limited to them. Note that the notifier 403 may send an alert notification based on the detection result of one of a photosensor 231, a proximity sensor 207, and the load detector 402. Note also that the example in which the three-dimensional shaping apparatus 400 is provided with the elastic members 401 in addition to the supporter 208 has been explained above. However, in the three-dimensional shaping apparatus 400, the elastic members 401 may be provided instead of the supporter 208.

FIG. 5 is a flowchart for explaining the operation procedure of the three-dimensional shaping apparatus according to this example embodiment. In step S501, the three-dimensional shaping apparatus 400 causes a moving unit to move the platform 205 in the vertical direction. In step S503, the three-dimensional shaping apparatus 400 detects whether the material storage 204 has moved downward. If it is detected that the material storage 204 has not moved downward (NO in step S503), the three-dimensional shaping apparatus 400 continues to move the platform 205; otherwise (YES in step S503), the three-dimensional shaping apparatus 400 advances to the next step. In step S505, the three-dimensional shaping apparatus 400 controls the movement of the platform 205 by the moving unit. That is, the three-dimensional shaping apparatus 400 stops the movement of the platform 205. In step S507, the three-dimensional shaping apparatus 400 determines whether the movement control of the platform 205 has ended. If the movement control of the platform 205 has not ended (NO in step S507), the three-dimensional shaping apparatus 400 continues the movement control of the platform 205; otherwise (YES in step S507), the three-dimensional shaping apparatus 400 ends the processing. Note that the flowchart shown in FIG. 5 is equally applicable in the three-dimensional shaping apparatus 200 described in the second example embodiment.

According to this example embodiment, since the load detector is provided, it is possible to control the movement of the platform more reliably, and thus position the platform accurately. Furthermore, since the movement of the platform can be controlled more reliably, it is possible to effectively prevent damage to the bottom surface of the material storage.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

What is claimed is:

1. A three-dimensional shaping apparatus for shaping a three-dimensional shaped object, comprising:
a material storage that stores a material of the three-dimensional shaped object;
a platform arranged facing said material storage;
a moving unit that moves said platform in a vertical direction;
a shaping pad that is provided on a surface, facing said material storage, of said platform, and on which the three-dimensional shaped object is shaped;
a first detector that detects downward movement of said material storage; and
a movement controller that controls, if the downward movement of said material storage is detected, the movement of said platform by said moving unit.

2. The apparatus according to claim 1, further comprising a second detector that detects a position of said platform,
wherein said movement controller controls the movement of said platform by said moving unit in correspondence with the detected position of said platform.

3. The apparatus according to claim 1, further comprising a supporter that supports said material storage.

4. The apparatus according to claim 1, wherein said material storage includes an elastic member on a lower surface.

5. The apparatus according to claim 1, further comprising a load detector that detects a load applied to said material storage between said platform and said shaping pad,
wherein said movement controller controls, based on the detected load, the movement of said platform by said moving unit.

6. The apparatus according to claim 5, further comprising a notifier that sends an alert notification based on a detection result of one of said first detector, said second detector, and said load detector.

7. The apparatus according to claim 1, wherein said material storage includes a member that can transmit a light beam.

8. The apparatus according to claim 7, wherein said member that can transmit the light beam contains glass.

9. A control method of a three-dimensional shaping apparatus for shaping a three-dimensional shaped object, including
a material storage that stores a material of the three-dimensional shaped object,
a platform arranged facing the material storage,
a moving unit that moves the platform in a vertical direction,
a shaping pad that is provided on a surface, facing the material storage, of the platform, and on which the three-dimensional shaped object is shaped,
a first detector that detects downward movement of the material storage, and
a movement controller that controls, if the downward movement of the material storage is detected, the movement of the platform by the moving unit,
the method comprising:
causing the moving unit to move the platform in the vertical direction;
detecting the downward movement of the material storage; and
controlling, if the downward movement of the material storage is detected, the movement of the platform by the moving unit.

10. A non-transitory computer readable medium storing a control program of a three-dimensional shaping apparatus for shaping a three-dimensional shaped object, including
a material storage that stores a material of the three-dimensional shaped object,
a platform arranged facing the material storage,
a moving unit that moves the platform in a vertical direction,
a shaping pad that is provided on a surface, facing the material storage, of the platform, and on which the three-dimensional shaped object is shaped,
a first detector that detects downward movement of the material storage, and
a movement controller that controls, if the downward movement of the material storage is detected, the movement of the platform by the moving unit,
the program for causing a computer to execute a method, comprising:
causing the moving unit to move the platform in the vertical direction;
detecting the downward movement of the material storage; and
controlling, if the downward movement of the material storage is detected, the movement of the platform by the moving unit.
